(19) United States
(12) Patent Application Publication
(10) Pub. No.: US 2005/0115046 A1
(43) Pub. Date: Jun. 2, 2005

(54) Methods and systems for fastening components, including composite aircraft panels

(76) Inventors: Mark A. Woods, Seattle, WA (US); Daniel M. Sherick, Seattle, WA (US); John Arthur Davies JR., Seattle, WA (US)

Correspondence Address: John M. Wechkin;Perkins Coie LLP, PO Box 1247, Seattle, WA, 98111-1247, US

(21) Appl. No.: 10/725,958

(22) Filed: Dec. 2, 2003

(51) Int. Cl. B23P 25/00; B23P 11/00

(52) U.S. Cl. 29/458; 29/505; 29/525.01; 29/525.05

(57) ABSTRACT

Methods and systems for fastening components, including composite aircraft components, are disclosed. A method in accordance with one embodiment includes inserting an elongated member through at least one component (e.g., a first hole in a first component and a second hole in a second component). A collar is then swaged onto a helical groove of the elongated member, with the first and second components positioned between the collar and a head of the elongated member, and with the collar positioned between the second component and a removable portion of the elongated member. The removable portion is removed, for example, as an axial tensile force is applied to the elongated member during the swaging process.

### TECHNICAL FIELD

The present invention is directed generally toward methods and systems for fastening components, including composite aircraft panels.

### BACKGROUND

The aircraft industry has developed a multitude of fasteners and fastening systems for quickly and reliably fastening aircraft components. One arrangement, provided by the Hi-Shear Corporation of Torrance, Calif., and referred to as a Hi-Lok® system, includes a pin that is typically forced (with a rivet gun or other power tool) into coaxially aligned holes of the two components to be fastened. Accordingly, the pin has an interference fit with the holes in the two components. The pin includes a head at one end that engages one of the components, and helical threads at the opposite end that project outwardly from the other component. In one specific arrangement, a nut or collar is threadably attached to the pin threads. The nut includes a shear section which fractures at a predetermined torque, leaving the rest of the nut tightened onto the pin with the predetermined torque. Alternatively, the pin can have axially spaced apart swage grooves, and the nut can be swaged rather than threaded onto the pin. In another arrangement, the end of the pin opposite the head can include a hexagonal broach which can receive a hex key to prevent the pin from rotating while the threaded collar is installed on the pin. However, a drawback with this approach is the broach may tend to strip, particularly when the pin is installed in a clearance hole (rather than an interference fit hole), which provides no gripping action on the pin. Further aspects of these arrangements are disclosed in U.S. Pat. Nos. 4,326,825; 4,485,510; and 4,957,401.

Another drawback with the foregoing arrangements is that the collar may inadvertently be cross-threaded onto the pin, reducing the security of the resulting bond. Accordingly, an alternate arrangement, (referred to in the industry as a lockbolt arrangement and available from Huck International, Inc. of Kingston, N.Y.), includes a pin having swage grooves for receiving a swaged collar, and a removable extension or pintail projecting outwardly from the swage grooves to receive an installation tool. In operation, the installation tool grips pintail grooves on the removable extension, pneumatically swages the collar onto the swage grooves, and simultaneously pulls the extension off in an axial direction. An advantage of this arrangement is that it may be relatively simple and reliable, and eliminates the possibility for cross-threading the collar on the pin. Another advantage is that it can be used in clearance holes without requiring the pin to be restrained against rotational motion.

Still another arrangement, available from the Hi-Shear Corporation, combines aspects of the two foregoing arrangements. This arrangement includes a pin having helical threads in the manner of a Hi-Lok® pin, together with a grooved, removable extension in the manner of a lockbolt. During installation, a tool grips the extension to pull the pin axially through the holes in the components. The extension is then broken off with an off-axis (e.g., lateral) force, and a threaded collar is installed on the threaded portion of the pin. One feature of this installation is that it is typically used when the pin has an interference fit with the holes into which it is inserted. Accordingly, the pin will not rotate when the threaded collar is installed.

While lockbolts may be easier to install in components having clearance holes (rather than interference fit holes), lockbolts also suffer from drawbacks.

For example, it may be desirable to coat the clearance holes with a sealant to make the joint between the attached components liquid-tight. The sealant can become trapped in the swage grooves of the lockbolt, reducing the gripping effectiveness of the swaged collar. One approach to addressing this drawback has been to add an axial sealant escape groove to the swage grooves, which allows the sealant to escape during the swaging operation. However, even this approach suffers from drawbacks. For example, the joint is generally not considered fluid-tight. Another approach to eliminating the sealing fluid from the swage grooves has been to wipe each pin before swaging on the collar. A disadvantage with this approach is that it is time consuming, which increases the cost of fabricating the associated aircraft components.

Still another approach has been to swage collars directly onto the threaded portion of a Hi-Lok®-type pin. However, this arrangement requires a complex and/or noisy C-shaped riveter to drive the pins through the components to be attached. Accordingly, the arrangement may be cumbersome to implement.

### SUMMARY

The present invention is directed generally toward methods and systems for fastening components, including composite aircraft components. A method in accordance with one aspect of the invention includes inserting an elongated member through at least one component (e.g., a first hole in a first component and a second hole in a second component), with a head of the elongated member positioned at least proximate to the first component. A collar is then swaged to a helical groove of the elongated member, with the first and second components positioned between the head and the collar, and with the collar positioned between the second component and a removable portion of the elongated member. The removable portion of the elongated member is then removed to complete the installation.

In one aspect of the invention, swaging the collar and removing the removable portion of the elongated member can include engaging the removable portion of the elongated member with a first portion of an installation tool, engaging the collar with a second portion of the installation tool, and moving at least one of the first portion and the second portion axially relative to the other. The elongated member can be inserted with an interference fit or a clearance fit, and can have a fluid applied to it (e.g., a sealing fluid) without obstructing the swaging operation. In another aspect of the invention, the elongated member and collar can be attached to a single component, for example, to fill a hole in the component.

A fastener system in accordance with another aspect of the invention includes a collar having an aperture, and an elongated member having a head portion and a shaft portion. The shaft portion is configured to be received in the aperture of the collar and includes at least one helical thread, a tool engagement portion, and a frangible portion between the at least one helical thread and the tool engagement portion. The frangible portion is configured to break under an axial tension when a tool engages the tool engagement portion and swages the collar onto the at least one helical thread.

In a further aspect of the invention, the fastener system can include an installation tool having a first portion positioned to engage the tool engagement portion of the elongated member, and a second portion positioned to contact the collar. At least one of the first and second portions is movable relative to the other, for example, to swage the collar onto the at least one helical thread and break the frangible portion of the elongated member.

### BRIEF DESCRIPTION OF THE DRAWINGS

FIG. 1 is a partially schematic, side elevation view of components of a fastener system configured in accordance with an embodiment of the invention.

FIG. 2 is a partially schematic, side elevation view of a portion of an elongated member configured in accordance with an embodiment of the invention.

FIG. 3 is a partially schematic, partially broken side elevation view of an elongated member configured in accordance with another embodiment of the invention.

FIG. 4 is a partially schematic, cross-sectional view of a tool for installing fastener system components in accordance with an embodiment of the invention.

FIGS. 5A-5C are flow diagrams illustrating methods for installing fastener system components in accordance with embodiments of the invention.

FIG. 6 is a partially schematic, partial cross-sectional side view of a tool positioned to install fastener components in accordance with an embodiment of the invention.

FIG. 7 is a partially schematic, side elevation view of fastener components and fastened components after completion of an installation procedure in accordance with an embodiment of the invention.

### DETAILED DESCRIPTION

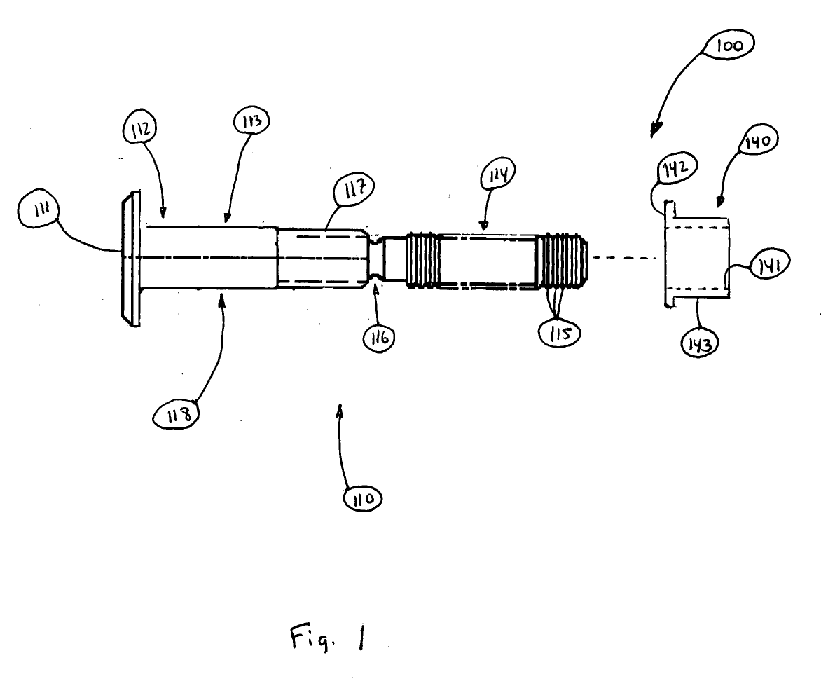

The present invention is directed generally toward methods and systems for fastening components, for example, aircraft components that include composite materials. Several embodiments of systems and methods for fastening such components are described below. A person skilled in the relevant art will understand, however, that the invention may have additional embodiments, and that the invention may be practiced without several of the details of the embodiments described below with reference to FIGS. 1-7.

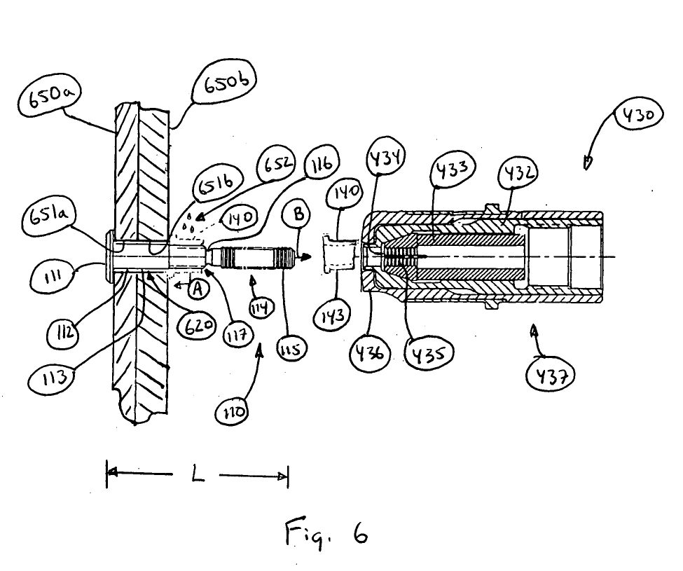

FIG. 1 is a partially schematic, side elevation view of a fastener system 100 that includes an elongated member 110 and a collar 140 configured in accordance with an embodiment of the invention. In one aspect of this embodiment, the elongated member 110 includes a head 111 and a shaft 118. The shaft 1 18 can include a first portion 1 12 and an adjacent second portion 113. The first portion 112 is configured to pass through a hole in a first component, and the second portion 113 is configured to pass through a hole in a second component prior to fastening the first and second components together, as described in greater detail below with reference to FIG. 6.

The elongated member 110 can further include a third portion 114 (e.g., an engagement portion) having engagement features 115, some of which are indicated schematically by phantom lines in FIG. 1. The engagement features 115 can be engaged by a tool (a) to support the elongated member 110 as the collar 140 is attached to the elongated member 110, and/or (b) to allow the tool to pull the elongated member 110 through the holes of the components to which it is fastened. In one aspect of this embodiment, the engagement features 115 include axially spaced apart, ring-shaped ridges. In other embodiments, the engagement features 115 include other elements, for example, helical grooves and/or knurled surfaces. A frangible region 116 is positioned between the third portion 114 and the first and second portions 112, 113, which allows the third portion 114 to be removed from the elongated member 110 during installation. A threaded portion 117 (having threads indicated schematically by dashed lines in FIG. 1) can be positioned between the frangible region 116 and the second portion 113. The threaded portion 117 is sized to securely engage the collar 140.

The collar 140 can include a barrel 143 having an aperture 141 and, optionally, a flange 142 disposed around the aperture 141. In a particular aspect of an embodiment shown in FIG. 1, the aperture 141 is large enough to slip over the engagement features 115 of the elongated member 110. In a further aspect of this embodiment, the aperture 141 is also large enough to slip over the threaded portion 117. Accordingly, the collar 140 securely engages the threaded portion 117 only after the collar 140 is swaged onto the threaded portion 117.

The material compositions of the elongated member 110 and the collar 140 can be selected based on criteria that include weight, strength and cost. In a particular embodiment, the elongated member 110 can include titanium and/or a titanium alloy. In other embodiments, the elongated member 110 can include Inconel®, steel and/or other materials. The collar 140 can include titanium, a titanium alloy, aluminum and/or other materials.

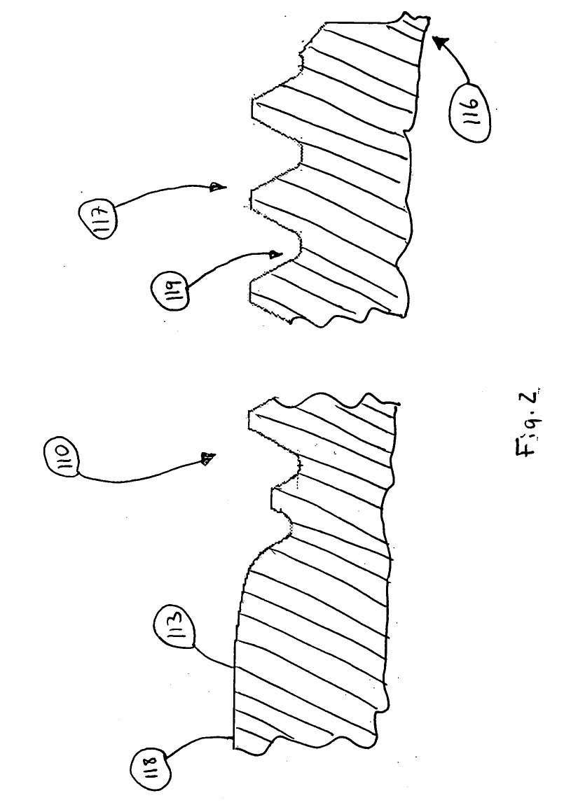

FIG. 2 is a cross-sectional illustration of part of the elongated member 110 described above with reference to FIG. 1. As shown in FIG. 2, the threaded portion 117 of the elongated member 110 can include a generally continuous, helical groove 119 extending at least approximately from the frangible portion 116 to the second portion 113 of the shaft 118. Although the helical groove 119 may be sized and manufactured in the manner of standard threads (e.g., threads that receive standard nuts), the helical groove 119 receives the collar 140 (FIG. 1) in a swaging operation, rather than a rotary torquing operation, as described in greater detail below with reference to FIG. 6.

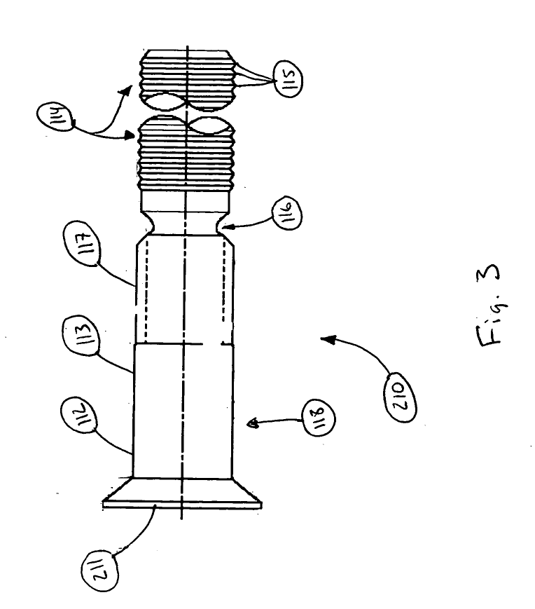

FIG. 3 is a partially schematic, partially broken side elevation view of an elongated member 210 configured in accordance with another embodiment of the invention. The elongated member 210 includes a shaft 118 having features generally similar to the shaft 118 described above with reference to FIG. 1. The elongated member 210 can further include a head 211 configured to be flush-mounted in a countersunk hole. Conversely, the head 111 described above with reference to FIG. 1 is configured to protrude from the hole after installation. The particular elongated member chosen for a specific application can depend upon whether the installation requires a flush-mount or protruding head. In other embodiments, the head or other parts of the elongated member can have other arrangements, again, depending upon the specific application(s) for which the elongated member is to be used.

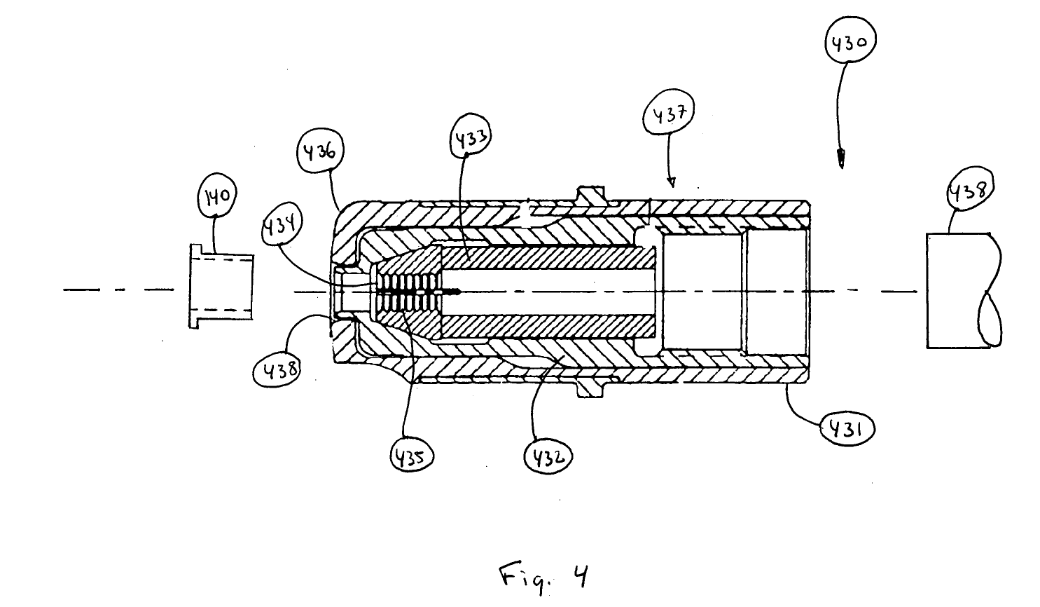

FIG. 4 is a partially schematic, cross-sectional illustration of a tool 430 configured to install elongated members (e.g., the elongated members 110, 210 described above with reference to FIGS. 1-3) in accordance with an embodiment of the invention. In one aspect of this embodiment, the tool 430 includes a driver 438 and an interchangeable nose portion 437. Suitable drivers 438 are available from Huck International, Inc. of Kingston, N.Y., under the trade name Pneudraulic Installation Tool. Suitable nose portions 437 are also available from Huck International, Inc.

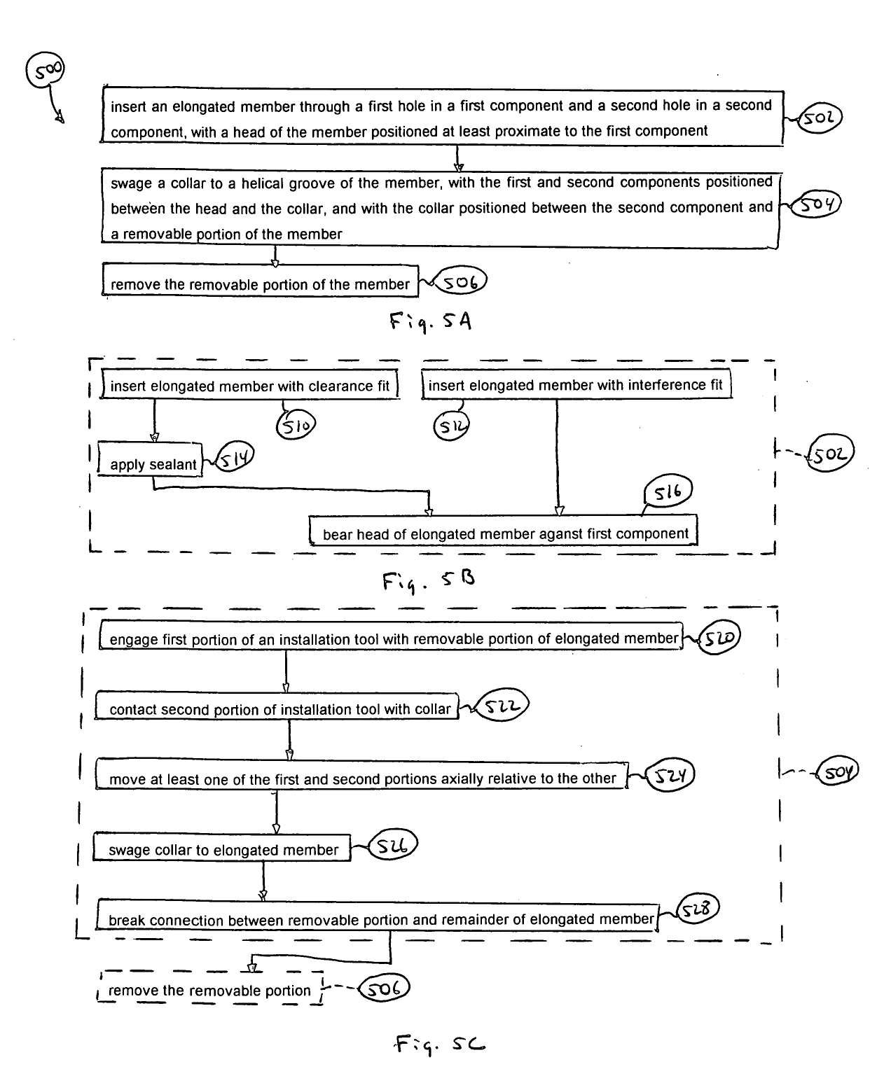

In one embodiment, the nose portion 437 includes a housing 431 carrying a collet 432 which in turn carries a chuck 433. The chuck 433 includes chuck aperture 434 (sized to receive the elongated member 110, 210 described above with reference to FIG. 1-3), and a grip portion 435 which is configured to be tightened by the collet 432 around the elongated member 110, 210 described above. An anvil 436 is positioned around the collet 432 and is movable relative to the collet 432. In one aspect of this embodiment, the anvil 436 has an anvil aperture 438 with a diameter smaller than an outer diameter of the collar 140. Accordingly, the anvil 436 can swage the collar 140 onto the elongated member 110, 210. Further details of this operation are described below with reference to FIGS. 5A-7.

FIG. 5A is a flow diagram illustrating a process 500 for fastening components in accordance with an embodiment of the invention. In one aspect of this embodiment, the process 500 can include inserting an elongated member through a first hole in a first component and a second hole in a second component, with a head of the elongated member positioned at least proximate to the first component (process portion 502). In process portion 504, a collar is swaged onto a helical groove of the elongated member, with the first and second components positioned between the head and the collar, and with the collar positioned between the second component and a removable portion of the elongated member. In process portion 506, the removable portion of the elongated member is removed, completing the installation process.

FIGS. 5B and 5C are flow diagrams illustrating details associated with specific embodiments of the process 500 described above with reference to FIG. 5A. Referring first to FIG. 5B, process portion 502 (inserting an elongated member through holes in the first and second components), can include inserting the elongated member with a clearance fit (process portion 510) or with an interference fit (process portion 512). If the elongated member is inserted with a clearance fit, it is loosely positioned in the holes and can accordingly be inserted into the holes relatively easily without the use of power tools and without the need for mechanically driving the elongated member through the holes. If the elongated member is inserted with an interference fit, it may be driven through the holes manually or with a power tool.

When the elongated member is installed with a clearance fit, the process 500 can optionally include applying a sealant (process portion 514) to seal the space between the walls of the hole and the exterior surface of the elongated member. In one aspect of this embodiment, the sealant can provide a liquid-tight connection between the elongated member and the first and second components that it fastens. Alternatively, the sealant can provide a less than liquid-tight seal, while still providing other functions, for example, corrosion resistance at the interface between the elongated member and the walls of the first and second holes into which it is inserted. Whether the elongated member is inserted with a clearance fit (with or without a sealant) or an interference fit, it can be inserted far enough so that the head of the elongated member bears against the first component (process portion 516).

Referring next to FIG. 5C, process portion 504 (swaging the collar onto a helical groove of the elongated member) can include engaging a first portion of an installation tool with a removable portion of the elongated member (process portion 520). For example, the installation tool can include a collet and chuck that apply a radial clamping force to the removable portion of the elongated member. In another embodiment, the installation tool can threadably engage the removable portion. In either embodiment, a second portion of the installation tool can then be contacted with the collar (process portion 522). At least one of the first and second portions is moved axially relative to the other (process portion 524) so as to swage the collar onto the helical groove of the elongated member (process portion 526). In process portion 528, the connection between the removable portion and the remainder of the elongated member is broken. In one aspect of this embodiment, the connection can be broken as the collar is swaged onto the elongated member. In another embodiment, the connection can be broken after the swaging process is completed. In either embodiment, the connection can be broken by applying an axial force to the connection. The removable portion can be removed after the connection is broken (process portion 506).

FIG. 6 is a partially schematic, cross-sectional illustration of the tool 430 positioned to install the collar 140 and the elongated member 110 described above, in accordance with an embodiment of the invention. For purposes of illustration, only the nose portion 437 of the tool 430 is shown in FIG. 6. In one aspect of this embodiment, a first component 650a having a first hole 651a is positioned adjacent to a second component 650b having a second hole 651b, so that the first hole 651a is axially aligned with the second hole 651b. In a further aspect of this embodiment, the first and second components 650a, 650b can include composite aircraft panels, for example, wing panels, fuselage panels, empennage panels or other external surface panels and/or structural panels. These panels can have a graphite/epoxy composite composition. In other embodiments, the first and second components 650a, 650b can include other elements having the same and/or other compositions. For example, the first component 650a and/or the second component 650b can include aluminum, titanium or associated alloys.

In a particular aspect of an embodiment shown in FIG. 6, the elongated member 110 has a clearance fit within the first hole 651a and the second hole 651b. Accordingly, the first portion 112 of the elongated member 110 has a diameter smaller than a diameter of the first hole 651a, and the second portion 113 of the elongated member 110 has a second diameter smaller than a diameter of the second hole 651b. If the resulting gap 620 between the elongated member 110 and the inner surfaces of the first and second holes 651a, 651b is to be sealed, a flowable sealant 652 can optionally be disposed in the gap 620. In a particular embodiment, the sealant 652 can include polysulfide. In other embodiments, the sealant 652 can be eliminated, and/or the first and second holes 651a, 651b can provide an interference fit with the elongated member 110.

When the elongated member 110 is installed through the first component 650a and the second component 650b, the head 111 of the elongated member 110 abuts against the first component 650a. The collar 140 is then passed along the elongated member 110 until it abuts against the second component 650b (as shown in dashed lines in FIG. 6). In other embodiments, other elements (e.g., washers) may be inserted between the head 111 and the first component 650a and/or between the collar 140 and the second component 650b. In any of these embodiments, the collar 140 can pass over the threaded portion 117 axially and without rotating either the collar 140 or the elongated member 110.

An operator (not shown) can then clamp the chuck 433 of the tool 430 around the engagement features 115 at the third portion 114 of the elongated member 110. The operator can then drive the anvil 436 away from the chuck 433 and against the collar 140 to swage the collar 140 onto the threaded portion 117 of the elongated member 110. In one aspect of this embodiment, the anvil 436 engages the barrel 143 of the collar 140 and, as it slides along the barrel 143, deforms collar 140 radially inwardly to mesh with the threaded portion 117. The anvil 436 also forces the collar 143 axially into tight engagement with the second component 650b. Accordingly, the anvil 436 provides an axial force in a first direction (as indicated by arrow A) on the collar 140, while the chuck 433 provides a reaction force on the elongated member 110 in an opposite axial direction (as indicated by arrow B).

As the axial force applied to the elongated member 110 increases beyond a threshold level, the frangible portion 116 of the elongated member 110 breaks, releasing the third portion 114 from the rest of the elongated member 110. At this point, the swaging operation ceases. The tool 430 can then be withdrawn and the removed third portion 114 discarded. In one embodiment, the frangible portion 116 is configured to break after at least part of the collar 140 is swaged to the elongated member 110, but before the progress of the anvil 436 is halted by the second component 650b. Accordingly, the anvil 436 will not apply a potentially damaging force directly on the second component 650b.

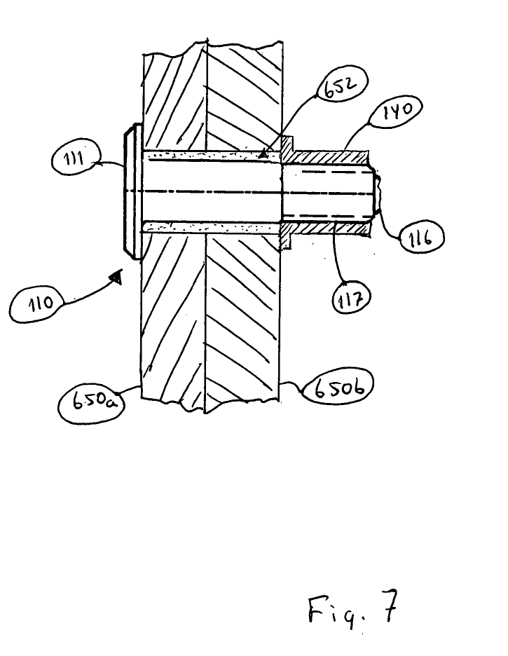

FIG. 7 illustrates the elongated member 110 and the collar 140 after the third portion 114 has been removed. As shown in FIG. 7, the elongated member 110 and the collar 140 provide a low profile, secure and (optionally) liquid-tight joint between the first component 650a and the second component 650b.

In other embodiments, the fastening system 100 described above can be used in other contexts. For example, the system 100 can be used to bond more than two components together by extending the elongated member through corresponding axially aligned holes of the components. In other embodiments, the system 100 can be used with a single component, for example, to seal a hole in a single panel. In one aspect of this embodiment, the head of the elongated member can bear on one surface of the component and the collar can bear on the opposite facing surface of the same component. Accordingly, the fastening operation described above can include fastening the elongated member and the collar to each other and to a single component, as well fastening multiple components to each other.

One aspect of an embodiment of the arrangement described above with reference to FIGS. 1-7 is that the elongated member 110 and the collar 140 can provide a secure, sealable attachment between the first component 650a and the second component 650b, even though the elongated member 110 may have a clearance fit in the first and second holes 651a, 651b. This feature is advantageous because it allows the arrangement to be used for a variety of applications (e.g., with composite materials) where it is more desirable to use clearance holes than interference fit holes. In particular, the clearance holes may allow the elongated member to be installed more quickly, more quietly and with less stress to the attached components 650a, 650b than is possible with conventional techniques, while still permitting a sealable connection.

Another feature of an embodiment of an arrangement described above with reference to FIGS. 1-7 is that the elongated member need not be secured against rotation while the collar is installed, because the collar is installed in a swaging operation. An advantage of this feature is that when the elongated member is installed in clearance holes, the operator need not use additional tools (e.g., a hex key) to prevent the elongated member from rotating as the collar is attached.

Still another feature of an embodiment of the arrangement described above with reference to FIGS. 1-7 is that the helical threads provide an avenue by which excess sealant on the elongated member can escape as the collar is swaged on. An advantage of this arrangement is that it can eliminate the need to manually remove excess sealant from the elongated member (e.g., by wiping), thereby reducing the time required to complete the assembly process.

Yet feature of an embodiment of the elongated member 110 described above and shown in FIG. 6 is that it can have an overall length L that is less than that of corresponding, existing pins. This is so because the elongated member 110 can slip through the first and second holes 651a, 651b with a clearance fit. Accordingly, the third portion 114 need not project so far outwardly from the second hole 651a as to allow the tool 430 to engage the third portion 114 and pull the elongated member through the holes 651a, 651b.) As a result, the elongated member 110 can include less material than an existing elongated member 110 sized for the same application and can accordingly be cheaper to manufacture.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method for fastening components, comprising:
inserting an elongated member through a first hole in a first component and a second hole in a second component, with a head of the elongated member positioned at least proximate to the first component;
swaging a collar to a helical groove of the elongated member, with the first and second components positioned between the head and the collar, and with the collar positioned between the second component and a removable portion of the elongated member; and
removing the removable portion of the elongated member.

2. The method of claim 1 wherein removing the removable portion of the elongated member is performed during, after, or during and after swaging the collar.

3. The method of claim 1 wherein inserting the elongated member through the first hole includes inserting the elongated member so that a first portion of the elongated member aligned with and received by the first hole has a diameter less than a diameter of the first hole, and wherein inserting the elongated member through the second hole includes inserting the elongated member so that a second portion of the elongated member aligned with and received by the second hole has a diameter less than a diameter of the second hole.

4. The method of claim 1, further comprising applying a liquid to the elongated member before swaging the collar, and swaging the collar without removing the liquid.

5. The method of claim 1 wherein swaging the collar and removing the removable portion of the elongated member include engaging the removable portion of the elongated member with a first portion of an installation tool, engaging the collar with a second portion of the installation tool, and moving at least one of the first portion and the second portion axially relative to the other.

6. The method of claim 1 wherein inserting the elongated member includes inserting the elongated member through a first hole in a first composite aircraft component and inserting the elongated member through a second hole in a second composite aircraft component.

7. The method of claim 1 wherein the elongated member is elongated along an axis and wherein removing the removable portion of the elongated member includes applying a force to the removable portion generally aligned with the axis.

8. The method of claim 1 wherein inserting the elongated member includes inserting the elongated member to have an interference fit with at least one of the first hole of the first component and the second hole of the second component.

9. The method of claim 1 wherein inserting the elongated member includes inserting the elongated member without a tool, and with the elongated member having a loose fit in the first and second holes.

10. The method of claim 1 wherein inserting the elongated member includes inserting the elongated member with the head bearing against the first component.

11. The method of claim 1 wherein swaging the collar includes swaging the collar to bear against the second component.

12. The method of claim 1 wherein swaging the collar includes applying an axial force and a radially inwardly directed force to the collar, without applying a torque to the collar.

13. The method of claim 1, further comprising passing the collar axially over the helical groove without rotating either the collar or the elongated member, prior to swaging the collar.

14. A method for fastening components, comprising:
inserting an elongated pin through a first hole in a first component and a second hole in a second component, with a head of the elongated pin positioned against the first component, the first hole having a first diameter greater than a diameter of a first portion of the elongated pin received in the first hole, the second hole having a second diameter greater than a diameter of a second portion of the elongated pin received in the second hole;
applying a fluid to the elongated pin;
swaging a collar to a helical groove of the elongated pin, with the collar positioned against the second component, and with the collar positioned between the second component and a third portion of the elongated pin;
breaking a connection located between the third portion of the elongated pin and the second portion of the elongated pin; and
removing the third portion of the pin.

15. The method of claim 14 wherein applying a fluid to the elongated pin includes applying a sealant.

16. The method of claim 14 wherein swaging the collar includes swaging the collar without removing the fluid from the elongated pin.

17. The method of claim 14 wherein swaging the collar and removing the removable portion of the elongated pin include engaging the third portion of the elongated pin with a first portion of an installation tool, engaging the collar with a second portion of the installation tool, and moving at least one of the first portion and the second portion axially relative to the other.

18. The method of claim 14 wherein inserting the elongated pin includes inserting the elongated pin through a first hole in a first composite aircraft component and inserting the elongated pin through a second hole in a second composite aircraft component.

19. The method of claim 14 wherein the elongated pin is elongated along an axis and wherein removing the third portion of the elongated pin includes applying a force to the third portion generally aligned with the axis.

20. The method of claim 14 wherein swaging the collar includes applying an axial force and a radially inwardly directed force to the collar, without applying a torque to the collar.

21. A method for sealably fastening aircraft components, comprising:
inserting an elongated pin through a first hole in a first composite aircraft component and a second hole in a second composite aircraft component, with a head of the pin positioned against the first composite aircraft component, the first hole having a first diameter greater than a diameter of a first portion of the elongated pin received in the first hole, the second hole having a second diameter greater than a diameter of a second portion of the elongated pin received in the second hole;
applying a flowable sealant to the elongated pin;
engaging a swaging tool with a third portion of the elongated pin, the second portion of the elongated pin being positioned between the first and third portions of the elongated pin;
swaging a collar to a helical groove of the elongated pin with the swaging tool so that the collar abuts against the second composite aircraft component, the helical groove being positioned between the third portion of the elongated pin and the second composite aircraft component;
breaking a connection located between the third portion of the elongated pin and the second portion of the elongated pin by applying an axial tension to the third portion while swaging the collar; and
removing the third portion of the elongated pin.

22. The method of claim 21 wherein swaging the collar and removing the removable portion of the elongated pin include engaging the third portion of the elongated pin with a first portion of the swaging tool, engaging the collar with a second portion of the swaging tool, and moving at least one of the first portion and the second portion axially relative to the other.

23. The method of claim 21, further comprising passing at least some of the flowable sealant along a helical path through the helical groove while swaging the collar to the helical groove.

24. The method of claim 21, further comprising passing the collar axially over the helical groove without rotating either the collar or the elongated pin, prior to swaging the collar.

25. The method of claim 21 wherein swaging the collar includes applying an axial and radially inwardly directed force to the collar, without applying a torque to the collar.

26. A fastening method, comprising:
inserting an elongated member through a hole in at least one component, with a head of the elongated member positioned at least proximate to the at least one component;
swaging a collar to a helical groove of the elongated member, with the at least one component positioned between the head and the collar, and with the collar positioned between the at least one component and a removable portion of the elongated member; and
removing the removable portion of the elongated member.

27. The method of claim 26 wherein removing the removable portion of the elongated member is performed during, after, or during and after swaging the collar.

28. The method of claim 26, further comprising applying a liquid to the elongated member before swaging the collar, and swaging the collar without removing the liquid.

29. The method of claim 26 wherein swaging the collar and removing the removable portion of the elongated member include engaging the removable portion of the elongated member with a first portion of an installation tool, engaging the collar with a second portion of the installation tool, and moving at least one of the first portion and the second portion axially relative to the other.

30. The method of claim 26 wherein the elongated member is elongated along an axis and wherein removing the removable portion of the elongated member includes applying a force to the removable portion generally aligned with the axis.

31. The method of claim 26 wherein inserting the elongated member includes inserting the elongated member without a tool, and with the elongated member having a loose fit in the hole.

32. The method of claim 26 wherein swaging the collar includes applying an axial force and a radially inwardly directed force to the collar, without applying a torque to the collar.

33. The method of claim 26, further comprising passing the collar axially over the helical groove without rotating either the collar or the elongated member, prior to swaging the collar.

34. A fastener system, comprising:
a collar having an aperture; and
an elongated member having a head portion and a shaft portion, the shaft portion being configured to be received in the aperture of the collar, the shaft portion including at least one helical thread, a tool engagement portion, and a frangible portion between the at least one helical thread and the tool engagement portion, the frangible portion being configured to break under an axial tension when a tool engages the tool engagement portion and swages the collar onto the at least one helical thread.

35. The fastener system of claim 34, further comprising the tool.

36. The fastener system of claim 34, further comprising the tool, and wherein the tool includes a first portion positioned to engage the tool engagement portion and a second portion positioned to contact the collar, and wherein at least one of the first and second portions is movable relative to the other.

37. The fastener system of claim 34 wherein the elongated member has a generally circular cross-section, and wherein the tool engagement portion includes at least one ridge extending circumferentially around the elongated member at a single axial location.

38. The fastener system of claim 34 wherein the engagement portion includes a plurality of spaced apart rings extending circumferentially around the elongated member.

39. The fastener system of claim 34 wherein the aperture of the collar is sized to slip axially over the at least one helical thread without rotating either the collar or the elongated member.

40. A fastener system, comprising:
a collar having an aperture;
an elongated pin having a head portion and a shaft portion, the shaft portion being configured to be received in the aperture of the collar, the shaft portion including at least one helical thread, a plurality of axially spaced-apart, circumferential ridges, and a frangible portion between the at least one helical thread and the circumferential ridges, the frangible portion being configured to break under an axial tension high enough to allow the collar to be swaged onto the at least one helical thread; and
an installation tool having a first portion positioned to engage the circumferential ridges, the installation tool having a second portion positioned to engage the collar, at least one of the first portion and the second portion being movable relative to the other to swage the collar onto the at least one helical thread, and break the frangible portion.

41. The system of claim 40 wherein the first portion of the installation tool includes a collet and the second portion includes an anvil having an axially extending aperture.

42. A fastener system, comprising:
first fastening means having an aperture; and
second fastening means configured to be received in the aperture of the first fastening means, the second fastening means including at least one helical thread, a tool engagement portion, and a frangible portion between the at least one helical thread and the tool engagement portion, the frangible portion being configured to break under an axial tension when a tool engages the tool engagement portion and swages the first fastening means onto the at least one helical thread.

43. The fastener system of claim 42, further comprising the tool, and wherein the tool includes a first portion positioned to engage the tool engagement portion and a second portion positioned to contact the first fastening means, and wherein at least one of the first and second portions is movable relative to the other.

44. An aircraft, comprising:
a first component having a first aperture;
a second component having a second aperture coaxially aligned with the first aperture;
an elongated member having a head portion positioned at least proximate to the first component, the elongated member further having a shaft portion extending through the first and second apertures, the shaft portion including at least one helical thread, the shaft portion further including at least part of a frangible portion that has been broken under an axial, tensile force; and
a collar having an aperture into which the elongated member is received, the collar being swaged onto the at least one helical thread of the elongated member.

45. The aircraft of claim 44 wherein at least one of the first and second components has a composite composition.

46. The aircraft of claim 44 wherein the first and second components include wing panels.

47. The aircraft of claim 44, further comprising a sealant disposed on the elongated member to seal a connection between the first and second components.

48. An assembly of components formed by a process, comprising:
inserting an elongated member through a first hole in a first component and a second hole in a second component, with a head of the elongated member positioned at least proximate to the first component;
swaging a collar to a helical groove of the elongated member, with the first and second components positioned between the head and the collar, and with the collar positioned between the second component and a removable portion of the elongated member; and
removing the removable portion of the elongated member by applying an axial tensile force to the removable portion to break a connection between the removable portion and a remainder of the elongated member, the remainder including at least part of a frangible portion that has been broken under the axial, tensile force.

49. The assembly of claim 48 wherein removing the removable portion of the elongated member is performed during, after, or during and after swaging the collar.

50. The assembly of claim 48 wherein inserting the elongated member through the first hole includes inserting the elongated member so that a first portion of the elongated member aligned with and received by the first hole has a diameter less than a diameter of the first hole, and wherein inserting the elongated member through the second hole includes inserting the elongated member so that a second portion of the elongated member aligned with and received by the second hole has a diameter less than a diameter of the second hole.

51. The assembly of claim 48, further comprising applying a liquid to the elongated member before swaging the collar, and swaging the collar without removing the liquid.

52. The assembly of claim 48 wherein inserting the elongated member includes inserting the elongated member through a first hole in a first composite aircraft component and inserting the elongated member through a second hole in a second composite aircraft component.

53. The assembly of claim 48 wherein the elongated member is elongated along an axis and wherein removing the removable portion of the elongated member includes applying a force to the removable portion generally aligned with the axis.
